(19) United States
(12) Patent Application Publication
(10) Pub. No.: US 2010/0304962 A1
(43) Pub. Date: Dec. 2, 2010

(54) SAFE COMBUSTION ADDITIVE AND METHODS OF FORMULATION

(76) Inventors: Allen A. Aradi, Glen Allen, VA (US); Stephen A. Factor, Richmond, VA (US); Gregory H. Guinther, Richmond, VA (US); Joseph W. Roos, Mechanicsville, VA (US)

Correspondence Address: Thomas & Karceski, P.C., 536 GRANITE AVENUE, RICHMOND, VA, 23226, US

(21) Appl. No.: 12/854,984

(22) Filed: Aug. 12, 2010

Related U.S. Application Data
(62) Division of application No. 11/623,402, filed on Jan. 16, 2007.

(51) Int. Cl. B01J 31/22

(52) U.S. Cl. 502/170

(57) ABSTRACT

A safe, metal-containing combustion additive and a method of formulation is directed for use in connection with utility and industrial furnaces. The additive includes a metal-containing catalyst, a ligand for complexing with the catalyst and a solvent for carrying the catalyst/ligand complex. The vapor pressure of the additive is less than about 200×10⁻⁵ Torr at 100° F.

This application is a divisional application of U.S. Ser. No. 11/623,402 that was filed on Jan. 16, 2007, which is incorporated in its entirety herein.

The present invention relates to metal-containing combustion additives for use in utility and industrial furnaces. Specifically, the additive and methods of for ululation are relatively safe from the perspective of health ratings, thereby resulting in more user-friendly working conditions.

### BACKGROUND

Oil and coal burning utility boilers and furnaces suffer from environmental issues due to particulate, NOₓ, and SOₓ pollutant emissions. As control of environmental emissions through additive treatment of fuels in use at utility power plants becomes increasingly important, the issue of safe storage and use of additives on the plant site gains more attention. Therefore utility power plant operators no longer just focus on the efficacy of the additive to perform as promised, but also are concerned about the safety of having such chemicals stored and used on site. As a result, it is desirable to formulate these additives with this point foremost in mind.

These additives have to be stored on site in reasonable amounts to perform the intended task without interruption of fuel treatment. This is because their peak effectiveness often depends on continuous treatment of the fuel to maintain a fresh active layer of additive combustion byproducts on the surfaces in the radiant zone (furnace) and convective zone (downstream of the furnace). Although most of these additives operate in the gas phase on combusting fuel vapor and particles, an induction period is often observed before signs of the intended effects are seen; implying that surface supported heterogeneous chemistry also plays a major role. Interruption in additive treat results in a shut down in surface supported activity, as the surface active layer is quickly covered with deposit from untreated fuel. To avoid this problem, additive suppliers need to store large amounts of additive on site, and these amounts can be tank trailer volumes (2,500 gallons and above). Additive storage locations on plant sites are usually above ground, semi-permanent, and permanent structures constructed by the additive supplier, with the exact location dictated by space in the proximity of the chosen fuel treatment location.

The HMIS hazard labeling of chemicals ranks the hazard level between 0 and 4, in order of decreasing safety. A chemical with a HMIS label of 1 or below is usually considered safe because exposure through aspiration is not dangerous. Anything above 1 may be considered potentially hazardous through skin contact, ingestion and aspiration and poses a storage and use safety risk requiring special precautions by those in the immediate environment.

### SUMMARY

Accordingly, it is an object of the present invention to provide a safe combustion additive and a method for formulating a safe combustion additive for use in utility and industrial furnaces that addresses the foregoing concerns and needs. The present invention not only addresses the requirements of HMIS standards, but also goes further by recognizing that inhalation through aspiration can be a significant health hazard in the real world where chemicals such as fuel additives may be handled.

In one example, a combustion additive for use in utility and industrial furnaces comprises a metal-containing catalyst. The additive further comprises a ligand for complexing with the catalyst, and a solvent for carrying the catalyst/ligand complex. The vapor pressure of the additive is less than about 200×10⁻⁵ Torr at 100° F. The catalyst may be comprised of a plurality of metals. The catalyst may be comprised of manganese. The catalyst may be comprised of a plurality of metals selected from the group consisting of manganese, calcium, magnesium, potassium, zinc and aluminum. The ligand may be selected from the group consisting of fossil fuel derived carboxylates, natural product derived carboxylates, genetically engineered natural product derived carboxylates, and synthetic carboxylates and mixtures thereof. The additive may have a HMIS health rating of 1 or 0. The vapor pressure of the additive may be less than about 70×10⁻⁵ Torr at 100° F.

In a further alternative, the invention includes a method of formulating a combustion additive for use in utility and industrial furnaces. The method includes selecting a metal containing catalyst for use in utility and industrial furnaces, complexing the metal containing catalyst with a ligand, and adding a solvent to carry the catalyst/ligand complex. The vapor pressure of the additive is less than about 200×10⁻⁵ Torr at 100° F. The catalyst may be comprised of a plurality of metals. The catalyst may be comprised of manganese. The catalyst may be comprised of a plurality of metals selected from the group consisting of manganese, calcium, magnesium, potassium, zinc and aluminum. The ligand may be selected from the group consisting of fossil fuel derived carboxylates, natural product derived carboxylates, genetically engineered natural product derived carboxylates, and synthetic carboxylates and mixtures thereof. The additive may have a HMIS health rating of 1 or 0. The vapor pressure of the additive may be less than about 70×10⁻⁵ Torr at 100° F.

### DETAILED DESCRIPTION

Health hazards may result from the following: inhalation, eye contact, skin contact, and ingestion of fuels and/or fuel additives. Health hazards caused by eye contact, skin contact, and inhalation can be prevented with warning signs on a container to wear gloves and avoid getting the chemical near the eyes or mouth. However, the “inhalation” hazard is more problematic in that by the time one reads the label they may have already been exposed.

To inhale something, it has to be in a vapor state, or a mist form. Therefore, the ability of an additive to convert to this physical state must be minimized. An additive formulation where the components exhibit a zero vapor pressure at ambient storage and handling conditions can reasonably be assumed to be benign with regard to passive inhalation by those handling it. Therefore, designing additives to minimize this health hazard dictates that first, the vapor pressure of all components in the formulation be minimized in the package. Second, the additive concentrate must be at a dilution level that lowers the HMIS health hazard rating of each component to “1” or below.

This invention aspires to minimize health exposure to additive formulations by means of the vapor vector. Most active ingredients in fuel additives are either high molecular weight compounds, or inorganics, or organometallics, all of which exhibit such low vapor pressures that exposure through aspiration is minimal. However, the fluidizing liquid matrix is likely to contain organics with relatively high vapor pressures. Volatilization of the additive active ingredients is facilitated by such low vapor pressure organics. This invention addresses that problem by providing a methodology to ensure that the additive fluidizing matrix itself exhibits a low vapor pressure.

Volatility is the key feature influencing the HMIS hazard ratings of metallic additives because of the potential danger of intake through aspiration. This invention recognizes that the volatility of such organometallic compounds is highly dependent on the ligands stabilizing the metal. Therefore the most important first step towards minimizing volatility of such organometallics is to choose ligands which themselves are non volatile and have a HMIS health hazard label of 1 or less. Such ligands include carboxylic acids such as naphthenic, salicylic, phenolic, tall oil derived fatty acids such as CENTURY 1164 (Arizona Chemical Co.), and other plant and animal derived fatty acids and mixtures thereof. To improve cold temperature properties, mixtures of carboxylic acids with alkyl group branchings and unsaturation are preferred because potential crystal lattice ordering with temperature lowering is disrupted. Unsaturation in the ligand backbone is highly preferred because of its role in laminar flame acceleration. Other ligands can be chosen from appropriate organosulfonates and organophosphonates.

This invention also recognizes that if solvents are desired to complete the additive formulation, then these solvents may also have a HMIS health hazard label of 1 or less. The use of the term in “solvents” herein includes generally carriers and fluidizers and other compounds for carrying the catalyst/ligand described herein. Such solvents can be found in low aromatic Group I and Group II basestocks with a cSt of 4 at 100° C. Examples of appropriate solvents are: 1) GP II 100SN, 98 VI at about 4.0 cSt at 100° C. from Motiva, and b) GP I 150SN, 88 VI with 4.5 cSt at 100° C. from ExxonMobil. Other solvents of similar characteristics and HMIS hazard label of 1 and below may also be used.

Single metals that may be derivatized according to this recipe to be used in utility power plants as combustion catalysts are Ca, Cr, Mn, Fe, Co, Cu (only with coal), Sr, Y, Ru, Rh, Pd, La, Re, Os, Ir, Pt, and Ce. The respective carboxylates can be made from the appropriate metal starting material (oxide, hydroxide, etc) and carboxylic acid and a solvent as defined above.

For a wider functional scope, multimetallics may be necessary. In such a case, a first co-catalyst may be necessary. For example, if additional slag modification is necessary, a magnesium carboxylate co-catalyst may be prepared according to the recipe above and blended with a single metal combustion catalyst as described above. The ratio of the catalyst/co-catalyst may span the range of 1/0.5 through 1/6. If the additive formulation is to be used in a vanadium containing fuel oil then the amount of the Mg co-catalyst should be about stoichiometric with the concentration of the vanadium in the fuel. When the combustion catalyst is Mn based, then the final formulation should be a concentrate designed to deliver between about 10 to 50 ppm Mn metal or about 20 to 30 ppm Mn metal. Since Mn, Pd, Pt and Cu based combustion catalysts are believed to be among the most efficient carbon burnout catalysts, the treat rates using metal carboxylate combustion catalysts such as those made from Ca, Cr, Fe, Co, Sr, Y, Ru, Rh, La, Re, Os, Ir, and Ce would likely have to be higher and may span the range of about 10-100 ppm, or alternatively, about 20-80 ppm metal.

In instances where the carbon containing combustion byproducts tend to form intractable sticky solids of large particle size, then a second co-catalyst derived from the alkali metal group (Li, Na, K, etc) may be necessary. Because of their low ionization energies, alkali metals are known to ionize very quickly in the flame and glom onto young soot as it forms. Being charged, they inhibit agglomeration of the soot particles thus maintaining the highest possible soot surface area to oxidation. Since this second co-catalyst's effectiveness is proportional to the number of atoms that ionize, rather higher concentrations may be necessary to achieve the desired goal. Therefore the alkali metal carboxylate in the formulation concentrate should be designed to deliver between about 10-500 ppm, or alternatively, about 20-100 ppm metal to the fuel.

Table 1 presents examples of additive formulations arrived at by following the concepts of this invention. In this set of examples, the metal catalyst that would under many circumstances push the HMIS health hazard rating of the respective additive formulation is manganese. At equal concentrations, the manganese from MMT would have a much higher risk to inhalation than that from manganese carboxylate, based on the fact that the former has a vapor pressure of 0.05 mm Hg at 20° C. while the latter exhibits a vapor pressure of 0.00 mm Hg at the same temperature. On this basis alone, use of Mn-carboxylate as the combustion catalyst in the additive formulations should yield a HMIS health hazard rating of less than “2” by inhalation, provided the carboxylic acid ligands and the solvents used are rated below a “2” as described elsewhere in this text.

Stationary Burner Additive Formulations Designed
to Minimize Exposure Through Inhalation.
Metal Ratios

| Examples | Mn | Ca | Mg | K | Zn | Al | Wt % Mn |
|---|---|---|---|---|---|---|---|
| 1 | 1 (MMT) | | | | | | 1.26 |
| 2 | 1 (MMT) | 9 (Lig) | | | | | 1.26 |
| 3 | 1 (MMT) | 7 (Lig) | 2 (Lig) | | | | 1.26 |
| 4 | 1 (MMT) | | 6 (Lig) | | | | 1.26 |
| 5 | 1 (MMT) | 3 (Lig) | 1 (Lig) | | 1 (Lig) | | 1.26 |
| 6 | 1 (MMT) | | 4 (Lig) | 1 (Lig) | | | 1.26 |
| 7 | 1 (MMT) | | | | 1 (Lig) | 4 (Lig) | 1.26 |
| 8 | 1 (MMT)/1 (Lig) | 3 (Lig) | 1 (Lig) | | | | 2.57 |
| 9 | 1 (MMT)/1 (Lig) | | | | | | 2.57 |
| 10 | 1 (MMT)/1 (Lig) | | | 1 (Lig) | | | 2.57 |
| 11 | 1 (MMT)/1 (Lig) | | 2 (Lig) | | | | 3.78 |
| 12 | 1 (MMT)/2 (Lig) | | | 1 (Lig) | 1 (Lig) | 3 (Lig) | 3.78 |
| 13 | 1 (MMT)/2 (Lig) | | 2 (Lig) | 1 (Lig) | | 3 (Lig) | 3.78 |
| 14 | 1 (Lig) | | | 0.2 (Lig) | 0.2 (Lig) | 0.5 (Lig) | 12 |

In Table 1, the metal ratios have units of weight percent (wt %). The main combustion catalyst is manganese either as methylcyclopentadienyl manganese tricarbonyl (MMT®) or a manganese carboxylate. “Lig” refers to “ligand” which may be carboxylic acid derived, acetylacetonate, chelating olefins, aromatics such as cyclopentadiene, and substituted cyclopentadienes, and other stabilizing ligands with a HMIS health hazard rating of “2” and below that promote oil solubility of the manganese compound. The co-catalysts are calcium (Ca) and potassium (K) derived organometallic compounds. Magnesium (Mg), zinc (Zn), and aluminum (Al) are slag and deposit modifiers. In general, magnesium and zinc are preferred for acidic slags and deposits (fuel oil combustion deposits), whereas zinc and aluminum are ideal for modifying basic slags (coal combustion deposits). Since manganese would be the metal with the highest HMIS rating in Table 1, the design of this invention focuses primarily on controlling the possible health hazard by inhalation of this metal. Pure commercial grade MMT (24.7% Mn) has a HMIS health hazard rating of “3”. On dilution to 5% MMT (1.26% Mn) the HMIS rating falls to a safe level of “1”, based on the dilution factor alone. That is where the “1.26” in the column titled “Wt % Mn” in the additive formulations comes from. Therefore, so long as MMT is a component of the package, this Mn concentration cannot be exceeded.

In order to increase the concentration of Mn in the formulations, a second source of Mn with a lower HMIS health hazard rating is used as a top treat. A typical example is a manganese carboxylate with a vapor pressure of 0.00 mm Hg at 20° C., with the logic here being, if it is not in the vapor phase at the plant storage site it cannot be inhaled.

Examples 1 to 7 are suitable additive formulations for use in fuel oil for improvement in combustion, opacity, slag/deposit, and minimization of both hot and cold corrosion.

Examples 8 to 14 are aimed at coal burning utility and other stationary burner set ups, with the same benefits as listed above.

The vapor pressures of commercially available additive fluidizer components were studied and from that study “superior” fluids were identified with vapor pressures of not more than 1.5×10⁻⁴ Torr at 68° F., and less than 70×10⁻⁵ Torr at 100° F. (see Table 2). These are the temperature conditions likely to be experienced during transportation, storage, and handling at end user sites. Similarly “good” fluids were identified with vapor pressures less than 5.0×10⁻⁴ Torr at 68° F. and less than 200×10⁻⁵ Torr at 100° F. (Table 3). The tabulated lists are but examples of suitable fluids. Of more importance are the respective vapor pressure ranges that can be used as a guide to select suitable fluidizing components.

TABLE 2
Superior Fluids

Temperatures Tested for
Vapor Pressures (° F.)
(in Torr × 10⁻⁵)

| Supplier | Oil Name | Group | 68 | 100 |
|---|---|---|---|---|
| Petro | P5300 | II | 0.14 | 1.00 |
| Canada | | | | |
| Petro | VHVI8 | III | 0.21 | 1.10 |
| Canada | | | | |
| Motiva | Star 12 | II | 0.07 | 3.70 |
| Petro | VHVI4 | III | 0.95 | 5.40 |
| Canada | | | | |
| Petro | VHVI6 | III | 1.70 | 9.00 |
| Canada | | | | |
| Petro | P1003 | (II+) | 6.60 | 32.00 |
| Canada | | | | |
| Petro | P2305 | II | 7.00 | 35.00 |
| Canada | | | | |
| Petro | P1020 | II | 9.00 | 43.00 |
| Canada | | | | |
| Petro | P1017 | II | 15.00 | 70.00 |
| Canada | | | | |

TABLE 3
Good Fluids

Temperatures Tested for
Vapor Pressures (° F.)
(in Torr × 10⁻⁵)

| Supplier | Oil Name | Group | 68 | 100 |
|---|---|---|---|---|
| SK | Yubase 4 | III | 18.00 | 75.00 |
| Petro | P1810 | II | 23.00 | 90.00 |
| Canada | | | | |
| Motiva | Star 5 | II | 40.00 | 170.00 |
| Petro | EVHVI24 | III | 47.00 | 200.00 |
| Canada | | | | |
| Petro | PL65 | II | 47.00 | 200.00 |
| Canada | | | | |

With the critical components thus defined, these additives may be formulated according to known techniques, with appropriate solvents and ancillary components (cold flow improvers, detergents, antistatic agents, etc) as need be. The ratios indicated may be changed to meet changing fuel compositions and burner/furnace/boiler operation parameters. This invention recognizes such differences and covers them.

Other metals that are combustion catalyst and may substitute in for Mn are Ca, Sr, Cr, Fe, Cu, Ru, Rh, Pd, La, Ir, Pt, and Ce. To determine safe concentrations, the same logic would apply with regard to vapor pressure and dilution.

Safer additive formulations made according to the recipe outlined above would be added to the fuel, combustion air, secondary air, overfire air, combustion charge, or flue gas in oil and coal burning furnaces and boiler systems to control emissions such as particulate and NOₓ; to minimize corrosion in the waterwall fuel rich regions near staged low-NOₓ burners, and to minimize low temperature corrosion in the flue gas by inhibiting oxidation of SO₂ to corrosive SO₃.

The invention is further directed to packaged products that contain the additive described herein. Briefly, the additive may be stored in packages prior to use—the packages including, but not limited to, drums, totes, barrels, tanks, etc. These packages would include indicia or labeling thereon, or otherwise near or in close proximity thereto, that indicates an HMIS health rating of one or zero. The unprecedented benefits of such labeling or indicia on a package are significant. Any person on or near a utility work site will know that the contents of the package are relatively safe and not volatile.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

Patentee does not intend to dedicate any disclosed embodiments to the public, and to the extent any disclosed modifications or alterations may not literally fall within the scope of the claims, they are considered to be part of the invention under the doctrine of equivalents.

What is claimed is:

1. A method of formulating a combustion additive for use in utility and/or industrial furnaces, the method comprising:
selecting a metal-containing catalyst for use in utility and/or industrial furnaces,
complexing the metal-containing catalyst with a ligand, and
adding a solvent to carry the catalyst/ligand complex,
wherein the vapor pressure of the additive is less than about 200×10⁻⁵ Torr at 100° F.

2. The method described in claim 1, wherein the catalyst is comprised of a plurality of metals.

3. A method as described in claim 1, wherein the catalyst is comprised of manganese.

4. A method as described in claim 2, wherein the catalyst is comprised of a plurality of metals selected from the group consisting of manganese, calcium, magnesium, potassium, zinc, copper and aluminum.

5. A method as described in claim 1, wherein the catalyst is comprised of a metal selected from the group consisting of manganese, calcium, magnesium, potassium, zinc, copper and aluminum.

6. A method as described in claim 1, wherein the ligand is selected from the group consisting of fossil fuel derived carboxylates, natural product derived carboxylates, and synthetic carboxylates and mixtures thereof.

7. A method as described in claim 1, wherein the additive has a HMIS health rating of one or zero.

8. A method as described in claim 1, wherein the additive has a HMIS health rating of one or zero.

9. A method as described in claim 1, wherein the pressure of the additive is less than 70×10⁻⁵ Torr at 100° F.

10. A method of minimizing health exposure to combustion additives to be used in utility and/or industrial furnaces, the method of using a safe combustion additive comprising:
selecting a metal-containing catalyst for use in utility and/or industrial furnaces,
complexing the metal-containing catalyst with a ligand, and
adding a solvent to carry the catalyst/ligand complex,
wherein the vapor pressure of the additive is less than about 200×10⁻⁵ Torr at 100° F.

11. A method as described in claim 10, wherein the pressure of the additive is less than 70×10⁻⁵ Torr at 100° F.
